(19) United States
(12) Patent Application Publication
(10) Pub. No.: US 2003/0225755 A1
(43) Pub. Date: Dec. 4, 2003

(54) Document search method and system, and document search result display system

(75) Inventors: Makoto Iwayama, Tokorozawa (JP); Yoshiki Niwa, Hatoyama (JP); Shingo Nishioka, Kawagoe (JP); Toru Hisamitsu, Oi (JP); Osamu Imaichi, Wako (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/374,090

(22) Filed: Feb. 27, 2003

(30) Foreign Application Priority Data
May 28, 2002 (JP) P2002-153927

(51) Int. Cl. G06F 7/00

(52) U.S. Cl. 707/3

(57) ABSTRACT

A system for classification is automatically determined in accordance with search results, and the search results are displayed in a list according to the classification system, thereby assisting an interactive search, such as one for refining the search results. A group of categories representing a group of documents retrieved is automatically extracted by clustering, the degree of belonging of each of the retrieved documents to each of the categories is calculated, and the proportions of the degrees of belonging are displayed by a bar graph. The search results can be rearranged according to the degree of belonging to a designated category.

### BACKGROUND OF THE INVENTION

1. Technical Field

The present invention relates to a method of automatically extracting categories representing a group of documents, such as search results, and automatically classifying and displaying the group of documents according to those categories.

2. Background Art

As more and more documents of various kinds are converted into electronic data, there is an increasing need for document retrieval. However, a searcher is often unable to produce an appropriate search request (query), thus failing to obtain desired search results. In this situation, it is necessary to analyze the search results and come up with the next search strategy.

One method that is gaining attention in the field of document search in recent years is based on automatic classification of search results, thus facilitating the refinement of search results. Examples are disclosed in “Scatter/Gather: A Cluster-based Approach to Browsing Large Document Collections”, ACM SIGIR' 92, pp. 318-329, 1992 (to be referred to as Prior Art 1), and JP Patent Publication (Unexamined Application) No. 2001-134582 entitled “News Topic Genre Inferring Apparatus, and Personal Topic Presenting Apparatus” (to be referred to as Prior Art 2).

Prior Art 1 automatically classifies search results by clustering and displays them. In this prior art, however, each document is classified into only one category. Most documents, however, are related to a plurality of topics and it is rare for a particular document to be able to be clearly classified into any single category. If the individual documents are classified into single categories, necessary documents which are related to other categories might be overlooked when refining search results according to a category.

In Prior Art 2, when classifying newspaper articles according to genres (categories), they are allowed to be classified into a plurality of genres, as opposed to Prior Art 1. However, the genres in the case of Prior Art 2 are specialized for newspaper articles, such as “Politics”, “Economy”, and “Sports”, and are thus predetermined in advance. In addition, these classifications are coarse and there are only five of them. In light of the purpose of refining search results, it is desirable that the classifications vary according to the search results. For example, if the group of documents obtained as a result of search concerns a news article about the weakening of yen, it would be necessary to subdivide the category “Economy”. Further, while in Prior Art 2, a list of related newspaper articles can be indicated by designating a category, the degree of relatedness or relevance between the individual newspaper articles and the category is not displayed. Thus, it is difficult for the user to provide feedback by, for example, designating a category after viewing the search results so that they can be rearranged.

In view of the above problems of the prior art, it is an object of the invention to provide a system for assisting an interactive search, such as one for refining search results, by automatically determining a group of categories representing search results and classifying and displaying the search results according to the group of categories.

### SUMMARY OF THE INVENTION

In order to achieve the above object of the invention, the category group as a reference for classification of search results must be adapted to the search results. The category group should be created dynamically in accordance with the search results, rather than a static one that is prepared in advance. Further, the documents as they are classified into a plurality of categories must be displayed in an “at a glance” manner, because it is rare that any document in search results only belongs to a single category. It is also necessary to enable the user to give his or her feedback by rearranging search results in accordance with a category of his or her interest.

To meet these requirements, a plurality of categories representing a group of retrieved documents are automatically extracted by clustering, and the degree of belonging of each of the retrieved documents to each of the multiple categories is calculated. The degrees of belonging are displayed on a screen, and, for a category designated by the user, the multiple retrieved documents are rearranged according to the degree of belonging to the designated category. Thus, the user can view the outline of the search results according to a group of categories that is adapted to the search results, and reorganize the search results according to a category of interest.

In one aspect, the invention provides a document retrieval method comprising the steps of:

searching a document database according to a search request;

representing each of a plurality of documents obtained by the search with a word vector having as elements words that appear;

classifying the multiple documents into a plurality of document groups (categories) by a clustering method using the word vectors;

representing each of the multiple document groups with a word vector having as elements words that appear;

calculating the degree of belonging of each document to each of the multiple document groups by using the word vector representing the document and the word vector representing the document group; and

outputting information identifying the multiple documents obtained by the search in association with the degree of belonging of each document to each of the multiple document groups.

The degree of belonging of each document to each of the multiple document groups may be calculated based on the distance between the word vector representing the document and the word vector representing the document group. The category of each document group may be expressed by representative words of the document group, and the user, viewing the words, can know the outline of the category that is automatically created. Further, when a document resembling a desired content is found in the documents obtained by the search, the category to which that document belongs may be picked out so that the retrieved documents can be rearranged in descending order of the degree of belonging to that category, thus refining the search results.

In another aspect, the invention provides a document retrieval system comprising:

a document retrieval unit for searching a document database in accordance with a search request;

a classification means for classifying a plurality of documents obtained by the search into a predetermined number of document groups (categories) according to similarity among the documents; and

a belonging-degree calculating unit for calculating the degree of belonging of each of the documents obtained by the search to each of the document groups.

The search results may be clustered into a number of document groups by representing the documents or the document groups in terms of a word vector and then using a clustering method. The belonging-degree calculating unit may calculate the degree of belonging of each document to each document group based on the distance between the word vector representing the document and the word vector representing the document group.

In another aspect, the invention provides a document retrieval result display system for displaying information about a plurality of documents obtained by a search, wherein the degree of belonging of each of the documents obtained by the search to a plurality of categories that are dynamically calculated based on the degree of similarity among the multiple documents obtained by the search is obtained.

The degree of belonging to each category may be displayed by a bar graph or a circular graph, where different categories may be displayed with different colors so that the degree of belonging of each document to each category can be immediately grasped.

The relevance of a document to the search request may be simultaneously displayed, and a bar graph may be displayed in which a bar with a length corresponding to the relevance to the search request is divided into portions in proportion to the degree of belonging to each category. Preferably, the multiple documents obtained by the search are initially displayed in descending order of relevance to the search request, and, when a category is designated, the documents are rearranged in descending order of relevance to the designated category. Further preferably, the system comprises a function for displaying a group of words characterizing a category that is designated, so that the contents of the category can be recognized.

### BRIEF DESCRIPTION OF THE DRAWINGS

FIG. 1 shows the structure of the search result display apparatus according to the invention when it is embodied in a server/client form via a network.

FIG. 2 shows a block diagram of the embodiment of the invention.

FIG. 3 shows a flowchart schematically illustrating an embodiment of the invention.

FIG. 4 shows an example of a bar graph indicating only the degree of belonging to each category.

FIG. 5 shows a system structure of the search result display apparatus according to the invention.

FIG. 6 shows an example of a circular graph (indicating the relevance by area).

FIG. 7 shows an example of a circular graph (indicating the relevance by diameter).

FIG. 8 shows an example of a search result display interface.

FIG. 9 shows examples of interaction in the search result display interface.

FIG. 10 shows an example of how the database is maintained and the maintenance fee is paid.

FIG. 11 shows an example of access right information.

### DESCRIPTION OF THE INVENTION

Embodiments of the invention will be described by referring to the attached drawings.

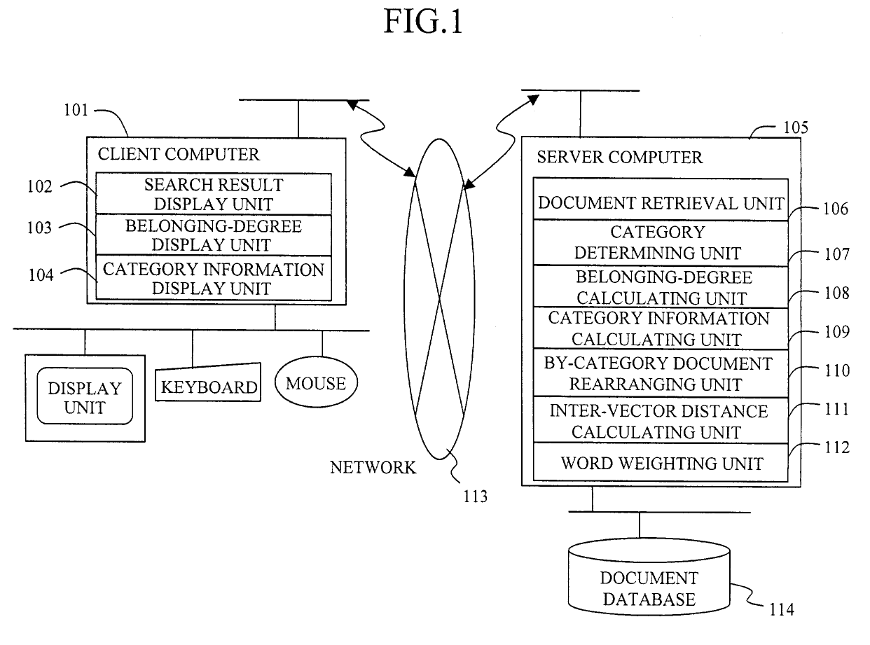

FIG. 1 shows an example of the system according to the invention. In this example, the invention is embodied in a server/client form via a network 113, so that a server provides search service to a client. A client computer 101 includes a search result display unit 102 for displaying search results, a belonging-degree display unit 103 for indicating the degree of belonging of each document to each category, and a category information display unit 104 for displaying information about a category. The client computer 101 is connected to input/output equipment including a display device, a keyboard, and a mouse. A server computer 105, which is connected to a document database 114, includes a document retrieval unit 106 for searching the document database 114 in accordance with a search request sent from the client computer, a category determination unit 107 for determining a group of categories based on a group of documents obtained by a search, a belonging-degree calculating unit 108 for calculating the degree of belonging of each of the retrieved documents to each category, a category information calculating unit 109 for calculating information about a category, a by-category document rearranging unit 110 for rearranging the documents as the search results in accordance with a category designation, an inter-vector distance calculating unit 111 used in the process of determining the category group and the degree of belonging of each document to each category, and a word weighting unit 112 for weighting each word that is extracted from a document. The connection between the server computer 105 and the document database 114 may be via the network 113.

The document database 114 is regularly or irregularly updated by a database administrator, and a user who uses the document database 114 by accessing the server computer via the client computer 101 pays a predetermined amount of fee to the administrator that varies depending on the volume of search or is fixed for a predetermined period.

The outline of a document retrieval processing by the present system is as follows. The details of each processing will be described later. First, the client computer 101 sends a search request given by a user to the server computer 105 via the network 113. The document retrieval unit 106 of the server computer 105 searches the document database 114 for a group of documents whose relevance to the search request sent from the client computer is high. Then, the category determination unit 107 of the server computer determines a category group, and the belonging-degree computing unit 108 of the server computer calculates the degree of belonging of each document to each category. The relevance to the search request and the degree of belonging to each category that have been calculated for each document are returned to the client computer 101 via the network 113. The client computer 101 displays search results on the search result display unit 102. Further, for each document, the relevance and the degree of belonging are displayed on the belonging-degree display unit 103 in the form of a bar graph, for example.

When a user wants to view the information about a category, he or she inputs a “Display category information” instruction to the client computer 101, which then sends the type of instruction and the ID of the subject category to the server computer 105. The server computer 105 calculates representative words in the category information calculating unit 109 and returns the result of calculation to the client computer 101, which then displays the resultant information on the category information display unit 104.

When the client computer 101 receives a “Rearrange by category” instruction from the user, it sends the type of instruction and the ID of the subject category to the server computer 105. In the server computer 105, the by-category document rearranging unit 110 rearranges the documents and returns a new arrangement to the client computer 101, which then displays the information about the new rearrangement.

Hereafter, the function of each portion of the client computer 101 and the server computer 105, the flow of each processing, and an example of a result display screen will be described in detail.

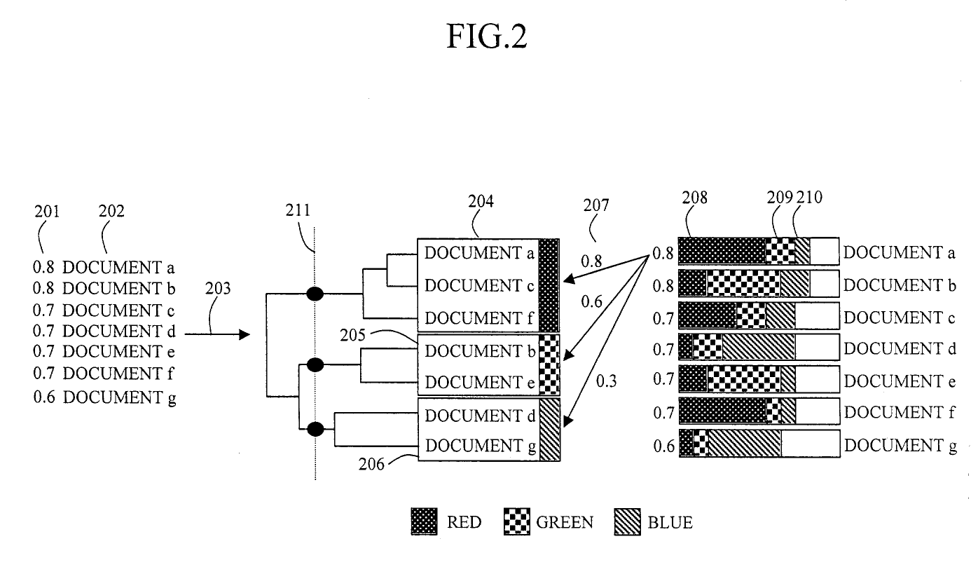

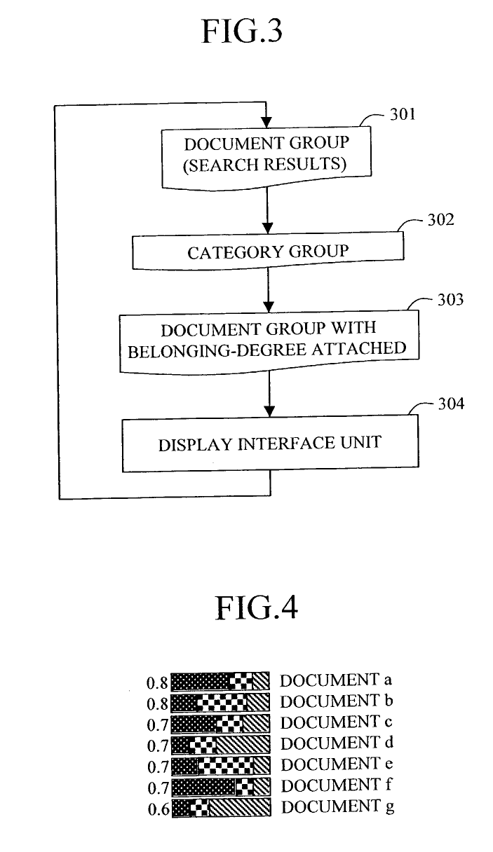

FIGS. 2 and 3 show a flowchart of the process according to the invention, and a block diagram. First, a group of documents 202, 301 to be displayed is given. In the present embodiment, a group of documents retrieved from the document database 114 according to some form of search request designated by the user is the subject of display. However, the invention is also applicable to a group of documents other than one obtained as a result of search. In FIG. 2, the values referenced by numeral 201 and assigned to each document indicate the relevance to the search request.

Next, the category determination unit 107 determines a category group 302 (203) that is used as a reference for classification. While there are cases where a category group is determined in advance, such as in the case of an encyclopedia, a category group is determined dynamically in accordance with the subject document group in the present invention. Thus, the category group in the invention is specialized for a given document group. The process of automatically determining a category group is based on a conventional clustering technique. As an example, a hierarchical bottom-up clustering technique that is performed in the category determination unit 107 will be described.

In the hierarchical bottom-up clustering technique, each document creates a cluster made up only of itself in an initial state. Namely, there are as many clusters as there are documents. In FIG. 2, there are seven clusters corresponding to documents a to g. Here, each document (cluster) is expressed by a vector having as elements words that appear. Each word as an element of the vector is weighted by the word weighting unit 112. There have been proposed a variety of methods of weighting, and the present invention is not particularly limited to any. Several examples are described by Salton, G. and McGill M., in “Introduction to Modern Information Retrieval”, McGraw-Hill Publishing Co., 1983. Most methods calculate weighting based on the frequency of appearance of words.

Then, the inter-vector distance calculating unit 111 calculates the distance between clusters for all of cluster pairs. As distance, in many cases the cosine between vectors is calculated. Pairs of clusters with a minimum distance in all of cluster pairs are merged. In the case of FIG. 2, a cluster consisting of document a and a cluster consisting of document c are merged first. The merged cluster also becomes a vector consisting of words as elements. Then, the distance between the merged cluster and each of the rest of the clusters is calculated and distance information is updated. Merger is continued in this way until there is only one cluster eventually. If it is now assumed that all the documents are merged into three clusters, the three clusters 204, 205, and 206 that have been obtained at the point of 211 can be employed.

Once a category group is determined, the belonging-degree calculating unit 108 calculates the degree of belonging of each document to each category (207). As a result, a group 303 of documents is obtained to which the degree of belonging to each category is attached. Upon completion of clustering, each document should belong to one category or another, thus at this point each document has zero degree of belonging to other categories. It is rare that a particular document belongs to only one category, and in most cases a document can be classified into more than one category. In the present invention, the degree of belonging of each document to each category is re-calculated once a category group is created, so that each document can be classified into multiple categories. As both the documents and the categories are expressed by vectors of words, the degree of belonging of a document to a category is based on the inter-vector distance (cosine) calculated in the inter-vector distance calculating unit 111. Of course, other methods of calculating the degree of belonging may be used.

The client computer 101 processes the information received from the server computer 105, displays the document group as search results on the search result display unit 102, and displays the degree of belonging of each document to each category on the belonging-degree display unit 103 by means of a bar graph, a circular graph, or the like. FIG. 2 shows to the right an example of display by a bar graph. When the document group as search results is displayed, the relevance to the search request is simultaneously displayed.

The belonging-degree display unit 103 displays the degree of belonging in the following manner, for example. Now it is assumed that the relevance to a search request is 0.8, the degree of belonging to a category 1 is 0.6, to a category 2, 0.3, and to a category 3, 0.2, where the relevance and the degrees of belonging are expressed by real numbers on a scale from 0 to 1.

When displaying by a bar graph, the colors of the categories are determined. It is now assumed that the category 1 is red, the category 2 is green, and the category 3 is blue. When the maximum length of a bar is 1, the relevance 0.8 to the search request is the total length of red, green, and blue. The length 0.8 is divided among the red, green, and blue. If the dividing is to be carried out in proportion to the degree of belonging, in the present case, red has a length of 0.8×0.8/(0.8+0.6+0.3). Similarly, green has a length of 0.8×0.6/(0.8+0.6+0.3), and blue has a length of 0.8×0.3/(0.8+0.6+0.3). Eventually, the degrees of belonging are displayed by the individual colors as in 208, 209, and 210, for example, of FIG. 2. This method will be referred to as Category Length Calculation Method 1. As the total length of red, green and blue is proportional to the relevance to the search request, it can be seen that the longer the total length, the more relevance the document has to the search request. Further, as the ratios of the red, green, and blue indicate the relevance of each document to each category, it can be immediately recognized to which category and to what degree a particular document belongs by looking at the length of each color.

In the case of the above method of calculation, a document that has a low relevance to the search request has a short total length of red, green, and blue. It is difficult, therefore, to see small differences between categories in such a document. Thus, a method can be employed whereby the relevance to the search request is expressed by numbers, with the bar graph displaying only the degrees of belonging to categories. This method will be referred to as Category Length Calculation Method 2. The display example of FIG. 4 corresponds to this case. Category Length Calculation Methods 1 or 2 can be selected by the user.

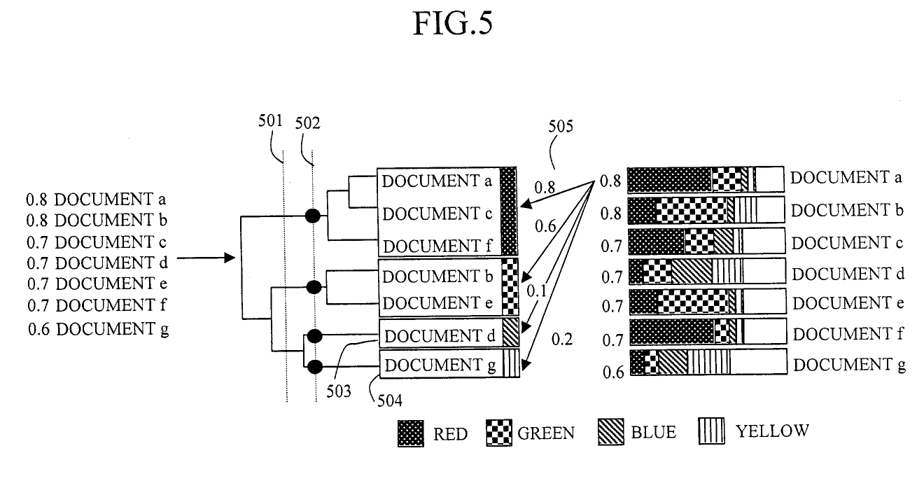

In the above description, three categories were assumed for convenience's sake. However, the present invention is not particularly limited to any particular number of categories, and the user can change the number of categories whenever he or she wishes. For example, when four categories are to be considered, four clusters are selected by the category determination unit (clustering) 107 and then displayed by a four-color bar graph. FIG. 5 schematically illustrates the process of changing the number of categories from 3 to 4. In the case of three categories, the three clusters that have been obtained at the point of 501 could be used. In the case of four categories, the four clusters that have been obtained at one point earlier in merging clusters, that is at a point 502, can be used. In reality, two clusters 503 and 504 are newly divided. In the end, the degree of belonging of each document to each cluster is calculated and displayed by a four-color bar graph (505).

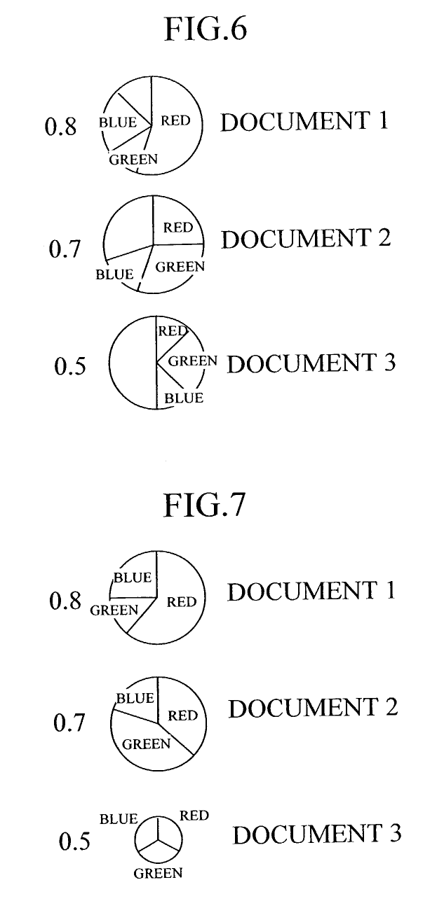

Categories can also be displayed in a manner other than by a bar graph. For example, a circular graph can be used, as shown in FIGS. 6 and 7. In these cases, the relevance to the search request may be indicated by the diameter of the circle, as in FIG. 7, or it can be indicated by the total area of red, green, and blue, while maintaining the diameter of the circle constant, as in FIG. 6. In addition to the methods of displaying classifications by a color bar or a circular graph with different colors, a method may be used whereby the relevance is indicated by mixed colors obtained by mixing individual colors in ratios corresponding to the degree of relevance.

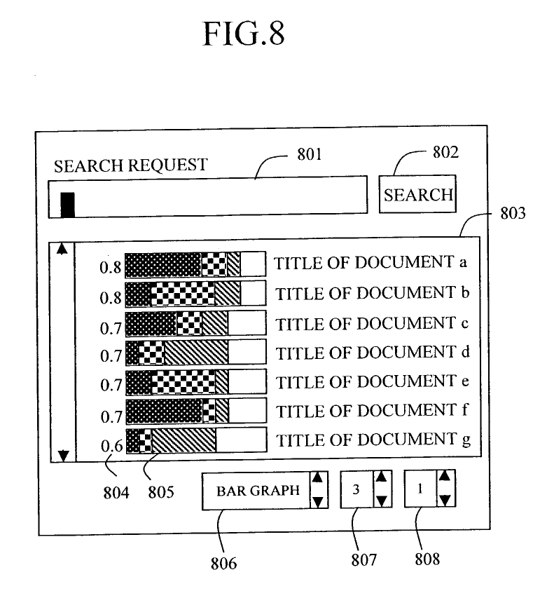

FIG. 8 shows an example of a search result display interface on the client computer 101. As a search request is input on a search request window 801 and a search button 802 is depressed, a search is initiated, and the result of search is displayed on a search result display window 803. Numeral 804 indicates the relevance to the search request, and 805 designates a bar graph indicating the degrees of belonging to categories. Numeral 806 designates a selection window for specifying the method of display of classification. For example, either a bar graph or a circular graph can be selected. Numeral 807 designates a selection window for specifying the number of categories, which, in the case of FIG. 8, is 3. Numeral 808 designates a selection window for specifying the method of calculating the length (area) of each category, which, in the illustrated example, is Category Length Calculation Method 1.

When the title of a document displayed on the search result display window 803 is clicked, the entire document is displayed on a separate window. In the present invention, as the search results are displayed, the initial arrangement of the documents is in the order of relevance to the search request. The user examines the thus arranged documents and finds a document of his or her interest at a certain point. By looking at a bar graph or a circular graph relating to the thus found document, the user can know to which category the document of his interest belongs. At that time, it is necessary for the user to understand what contents each category has. This is particularly the case with the present invention, where the categories are automatically determined.

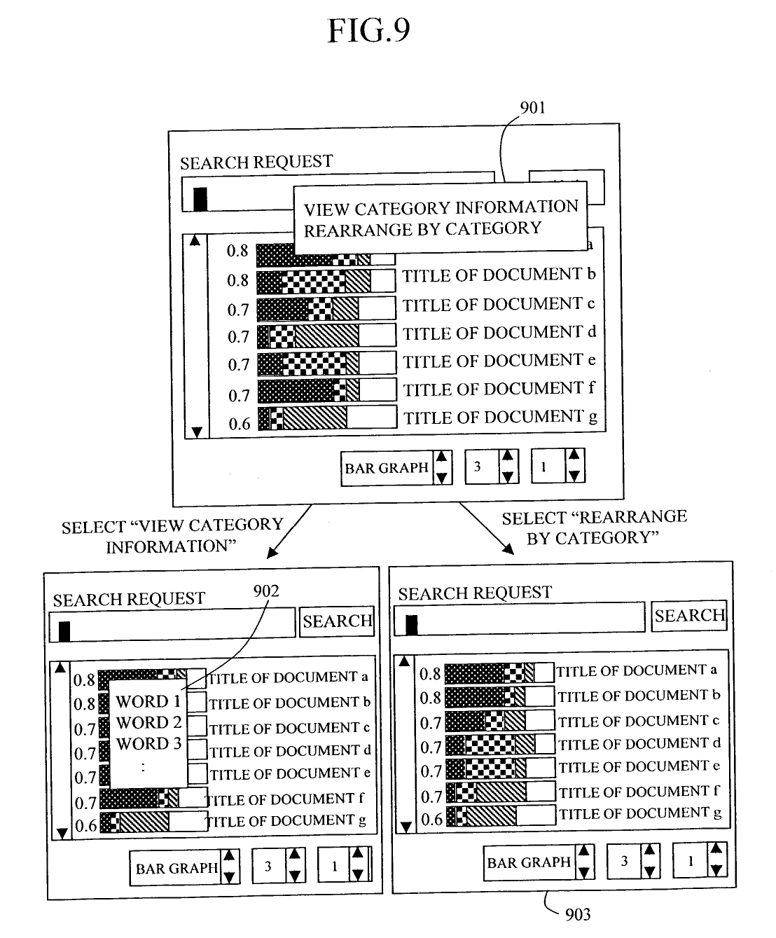

In the present invention, representative words of each category can be viewed on the category information display unit 104 as category information. The search result display interface shown in FIG. 9 displays a pop-up menu 901 when a portion corresponding to a category of interest in the bar graph is clicked. FIG. 9 shows how, when an item “View category information” in the menu is selected, a category information window 902 pops up. In order to display the representative words of a particular category, it is necessary to calculate the degree of representation of a word in the category in one form or another. In the present invention, as a category is a document cluster, that is a vector of words, the words are already weighted during the step of clustering by the word weighting unit 112. Thus, the contents of a category can be known by displaying words that are weighted heavily. It is of course possible to display the category information in different manners.

The user, upon finding a category of his or her interest, can collect documents related to the category of interest by means of the by-category document rearranging unit 110. Specifically, the documents are rearranged in the order of the length (area) of the category of interest. A display screen 903 of FIG. 9 displays the result of rearranging the documents after the pop-up menu 901 was displayed when a portion of the bar graph corresponding to the category indicated by red was clicked and the passage “Rearrange by category” was selected. As shown, the documents are rearranged in descending order of the degree of belonging to the category indicated by red.

By thus rearranging, documents related to a particular category can be collected, thereby facilitating the refining of search results. Further, the dynamic manner in which the categories by which the information is organized are set can help find new perspectives that have hitherto been unthought of. Because the rearranging can be carried out repeatedly, a process of trial and error can be repeated with different categories or methods of rearrangement when results are not satisfactory.

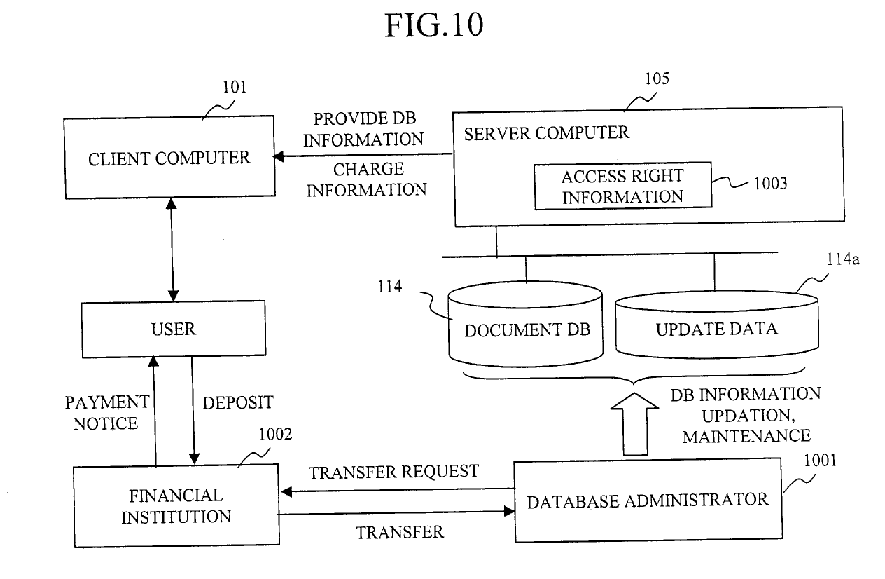

The document database 114 is updated or otherwise maintained by the database administrator, and a maintenance fee is paid by the user to the database administrator. FIG. 10 illustrates an example of how the document database is maintained and the maintenance fee is paid. A database administrator 1001 maintains the document database 114 by, for example, updating its information on a regular or irregular basis. If the document data is updated once every six months, the differential data for a six-month period that has been added by updating is managed as update data 114a. After the document database is updated by the database administrator 1001, the user, when he or she accesses the document database, is notified by the server computer 105, via the screen of the client computer 101, of the fact that there are update data in the document database and that a payment of additional fee is required if the updated information is to be utilized.

If the user accepts to pay the additional fee and carries out necessary procedures on the screen of the client computer 101 for paying the fee through his or her bank account or credit card, access right information 1003 held by the server computer is updated, enabling the user to utilize the update data 114a. Unless the user carries out the procedures for paying the additional fee, he or she cannot use the update data 114a. The server computer 105 manages information as to which user is allowed access to what extent of data by referring to the access right information 1003. When the user carries out the procedures for paying the additional fee, that information is handed over to the database administrator 1001, who in turn asks a financial institution 1002 for a money transfer. After necessary procedures are carried out, the fee is transferred from the financial institution 1002 to the database administrator 1001. The financial institution meanwhile notifies the user of completion of money transfer.

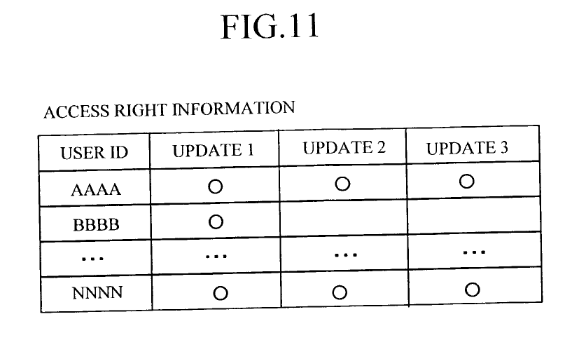

FIG. 11 shows an example of the access right information 1003, in which information indicating to which update data individual users are allowed access is stored. In the illustrated example, the circles indicate that the particular user has access right. For example, the user with the user ID “AAAA” can utilize differential data for “UPDATE 1”, “UPDATE 2”, and “UPDATE 3”. While the user with the user ID “BBBB” can utilize differential data for “UPDATE 1”, he or she cannot utilize differential data for both “UPDATE 2” and “UPDATE 3”. The contents of the access right information are updated whenever necessary in accordance with fee-payment status.

The functions of the client computer and those of the server computer according to the invention can be realized by programs. The programs may be loaded onto the computers via recording media such as a CD-ROM, a DVD-ROM, an MO, and a floppy disc and executed thereon, or they can be loaded onto the computers via a network and executed thereon.

Thus, in accordance with the present invention, the user can grasp the outline of search results based on the category information, and classify them by a category of his or her interest. Thus, the user can refine the search results or find perspectives in the search results that he or she has not hitherto thought about. Because the category group is dynamically extracted from the search results, the category group is adapted to the search results at all times, as opposed to a category group that is prepared in advance.

What is claimed is:

1. A document retrieval method comprising the steps of:
searching a document database according to a search request;
representing each of a plurality of documents obtained by the search with a word vector having as elements words that appear;
classifying the multiple documents into a plurality of document groups by a clustering method using the word vectors;
representing each of the multiple document groups with a word vector having as elements words that appear;
calculating the degree of belonging of each document to each of the multiple document groups by using the word vector representing the document and the word vector representing the document group; and
outputting information identifying the multiple documents obtained by the search in association with the degree of belonging of each document to each of the multiple document groups.

2. The document retrieval method according to claim 1, wherein the degree of belonging of each document to each of the multiple document groups is calculated on the basis of the distance between the word vector representing the document and the word vector representing the document group.

3. The document retrieval method according to claim 1, further comprising the step of outputting the words in the word vector representing a designated document group as the category of the document group.

4. The document retrieval method according to claim 1, further comprising the step of rearranging the multiple documents obtained by the search in descending order of the degree of belonging of the documents to a designated document group.

5. A document retrieval system comprising:
a document retrieval unit for searching a document database in accordance with a search request;
a classification means for classifying a plurality of documents obtained by the search into a predetermined number of document groups according to similarity among the documents; and
a belonging-degree calculating unit for calculating the degree of belonging of each of the documents obtained by the search to each of the document groups.

6. The document retrieval system according to claim 5, wherein the classification means classifies the multiple documents obtained by the search by a clustering method.

7. The document retrieval system according to claim 5, further comprising means for representing the documents or the document groups by a word vector.

8. The document retrieval system according to claim 7, wherein the belonging-degree calculating unit calculates the degree of belonging of each document to each document group on the basis of the distance between the word vector representing the document and the word vector representing the document group.

9. The document retrieval system according to claim 7, further comprising means for outputting the words in the word vector representing a designated document group as the category of the document group.

10. The document retrieval system according to claim 5, further comprising means for rearranging the multiple documents obtained by the search in descending order of the degree of belonging to a designated document group.

11. The document retrieval system according to claim 5, wherein the document database has differential document data that has been added by data updation, and access right information in which users who are allowed access to the differential document data are registered.

12. A document retrieval result display system for displaying information about a plurality of documents obtained by a search, wherein the degree of belonging of each of the documents obtained by the search to a plurality of categories that are dynamically calculated based on the degree of similarity among the multiple documents obtained by the search is displayed.

13. The document retrieval result display system according to claim 12, wherein the degree of belonging to each category is displayed by a bar graph or a circular graph.

14. The document retrieval result display system according to claim 12, wherein different categories are displayed with different colors.

15. The document retrieval result display system according to claim 12, wherein the relevance of a document to a search request is additionally displayed.

16. The document retrieval result display system according to claim 15, wherein a bar graph is displayed in which a bar with a length corresponding to the relevance to the search request is divided into portions in proportion to the degree of belonging to each category.

17. The document retrieval result display system according to claim 12, comprising a function for displaying the multiple documents obtained by the search in descending order of relevance to a search request.

18. The document retrieval result display system according to claim 12, comprising a function for rearranging the multiple documents obtained by the search in descending order of the degree of belonging to a designated category.

19. The document retrieval result display system according to claim 12, comprising a function for displaying a group of words characterizing a designated category.
